(19) United States
(12) Patent Application Publication
(10) Pub. No.: US 2005/0156838 A1
(43) Pub. Date: Jul. 21, 2005

(54) Driver circuit of semiconductor display device and driving method thereof and electronic apparatus

(76) Inventors: Keisuke Miyagawa, Kanagawa (JP); Tomoyuki Iwabuchi, Kanagawa (JP); Ryo Nozawa, Kanagawa (JP); Yasunori Yoshida, Kanagawa (JP); Akihiro Kimura, Kanagawa (JP)

Correspondence Address: FISH & RICHARDSON P.C., P.O. BOX 1022, MINNEAPOLIS, MN, 55440-1022, US

(21) Appl. No.: 11/008,137

(22) Filed: Dec. 10, 2004

(30) Foreign Application Priority Data
Dec. 24, 2003 (JP) 2003-426210

(51) Int. Cl. G09G 3/30

(52) U.S. Cl. 345/77

(57) ABSTRACT

A semiconductor display device that operates normally at a room temperature may not operate normally at a low temperature. Meanwhile, in semiconductor display devices with the same circuit configuration and the same driving method, the higher the operating frequency is, the better the display quality is. Thus, a semiconductor display device the operating frequency of which is set on the basis of a room temperature may not operate normally at a low temperature. According to the invention, the temperature and the operating state of a semiconductor display device are measured to vary the operating frequency in accordance with the measurement result. More specifically, the operating frequency is decreased at a low temperature to obtain normal operation, while the operating frequency is increased at a room temperature and a high temperature to improve the display quality.

### BACKGROUND OF THE INVENTION

1. Field of the Invention

The present invention relates to a driver circuit of a semiconductor display device having a semiconductor element, and a driving method thereof. In particular, the invention relates to a driver circuit of a semiconductor display device using a light emitting element in a pixel portion, and a driving method thereof

2. Description of the Related Art

In recent years, a display device using a light emitting element such as an electro luminescence (EL) element has been actively developed. A self-luminous light emitting element provides high visibility and requires no back light needed in a liquid crystal display device (LCD) or the like, leading to reduction in thickness and wide viewing angle.

An EL element generally emits light when a current is supplied thereto. Therefore, different driving methods from those of an LCD are suggested (see Non Patent Document 1, for example).

Non Patent Document 1: Dictionary of Flat Panel Display Technology, Kogyo Chosakai Publishing Co., Ltd., December 2001, pp. 445-458

### SUMMARY OF THE INVENTION

In a display device, particularly in a semiconductor display device using a semiconductor element, the operating temperature is related to the maximum operating frequency. For example, the maximum operating frequency is different in a high temperature (approximately 80° C.), a room temperature (approximately 27° C.), and a low temperature (approximately −40° C.). In particular at a low temperature, the maximum operating frequency is decreased as shown in FIG. 10. That is, a semiconductor display device that operates normally at a room temperature may not operate normally at a low temperature.

In the semiconductor display devices with the same circuit configuration and the same driving method, the higher the operating frequency is, the better the display quality is. For example, the higher the frame frequency is, the less apparent the image flicker is. In a time gray scale method, increased gray scale levels result in higher operating frequency. That is, in order to achieve better display quality, the operating frequency is required to be set as high as possible.

In general, the semiconductor display device is required to operate in a wide temperature range from a low temperature to a high temperature. When the operating frequency is determined on the basis of a room temperature, normal operation may not be obtained at a low temperature. Therefore, the operating frequency is determined on the basis of the most severe conditions, namely a low temperature herein. As a result, display quality at a low temperature is applied to at a room temperature and a high temperature. However, it is disadvantageous that display quality at a low temperature is applied to at a room temperature and a high temperature at which better display quality should have been obtained.

In view of the foregoing, the invention provides a semiconductor display device in which the best display quality can always be obtained from at a low temperature to a high temperature.

According to the invention, the temperature and the operating state of a semiconductor display device are measured to vary the operating frequency in accordance with the measurement result. In particular, the operating frequency is decreased at a low temperature to obtain normal operation whereas the operating frequency is increased at a room temperature and a high temperature to improve display quality.

The invention comprises a temperature sensor for measuring the temperature of a display panel, a video driver for supplying a control signal and a video signal, an analog/digital converter for measuring the output value of the temperature sensor, and a means for varying the frequencies of the control signal and the video signal in accordance with the measurement result of the analog/digital converter.

The invention comprises an output signal detection circuit for monitoring an output signal terminal, a video driver for supplying a control signal and a video signal, and a means for varying the frequencies of the control signal and the video signal in accordance with operating state data obtained from the output signal detection circuit.

The invention comprises a video driver for supplying a control signal and a video signal to a display panel, and a means for varying the frequencies of the control signal and the video signal in accordance with a setting signal inputted to the video driver.

The invention comprises an analog/digital converter and a video driver. The analog/digital converter measures the output value of a temperature sensor, the video driver supplies a control signal and a video signal to a display panel, the temperature sensor measures the temperature of the display panel, and the frequencies of the control signal and the video signal are varied in accordance with the measurement result of the analog/digital converter.

The invention comprises an output signal detection circuit and a video driver. The output signal detection circuit monitors an output signal terminal of a display panel, the video driver supplies a control signal and a video signal to the display panel, and the frequencies of the control signal and the video signal are varied in accordance with operating state data obtained from the output signal detection circuit.

The invention comprises a video driver that supplies a control signal and a video signal to a display panel. The frequencies of the control signal and the video signal are varied in accordance with a setting signal inputted to the video driver.

Better display quality can be obtained at a room temperature and a high temperature while maintaining normal operation at a low temperature. Accordingly, a wide range of an operating temperature of a display panel and better display quality can both be achieved.

### BRIEF DESCRIPTION OF THE DRAWINGS

FIG. 1 is a diagram showing an embodiment mode of the invention.

FIG. 2 is a diagram showing an embodiment mode of the invention.

FIG. 3 is a diagram showing an embodiment mode of the invention.

FIG. 4 is a diagram showing an example of a column selection driver of the invention.

FIG. 5 is a diagram showing an example of a row selection driver of the invention.

FIG. 6 is a diagram showing an example of a video driver of the invention.

FIGS. 7A, 7B1 and 7B2 are diagrams showing a method of varying a frame frequency according to the invention.

FIGS. 8A to 8C are diagrams showing a method of decreasing the frequencies of a control signal and DATA according to the invention.

FIGS. 9A to 9F are views showing examples of electronic apparatuses to which the invention can be applied.

FIG. 10 is a graph showing a relationship between the temperature and the maximum operating frequency of a display panel.

### DETAILED DESCRIPTION OF THE INVENTION

Although the invention will be described by way of Embodiment Modes and Embodiments with reference to the accompanying drawings, it is to be understood that various changes and modifications will be apparent to those skilled in the art. Therefore, unless such changes and modifications depart from the scope of the invention, they should be constructed as being included therein.

### EMBODIMENT MODE 1

FIG. 1 shows an embodiment mode of the invention. According to this embodiment mode, the operating frequency is varied in accordance with the measurement result of a temperature sensor.

The invention comprises a display panel 100 and a driver circuit 110. The display panel 100 comprises a pixel 101, a column selection driver 102, a row selection driver 103, and a temperature sensor 104. The column selection driver 102 and the row selection driver 103 may be constituted by thin film transistors (TFTs) formed on the same insulator as the pixel 101, or may be attached onto an insulator by COG (Chip On Glass). Similarly, the temperature sensor 104 may be formed on the same insulator as the pixel 101, or may be attached to an insulator. Since the temperature sensor 104 is provided to measure the temperature of the display panel 100, it is not necessarily attached to the display panel 100, though it is preferably disposed as close to the display panel 100 as possible.

The driver circuit 110 comprises a video driver 111 and an analog/digital converter (ADC) 112. The ADC 112 may incorporate the temperature sensor 104.

The column selection driver 102 receives a control signal and a video signal (DATA) from the video driver 111. The row selection driver 103 receives a control signal from the video driver 111. The row selection driver 103 scans the pixel 101 in accordance with the control signal whereas the column selection driver 102 writes the video signal (DATA) to the pixel 101 in accordance with the control signal. The written video signal (DATA) allows the pixel 101 to display a predetermined image.

The ADC 112 receives temperature data of the display panel 100 measured by the temperature sensor 104, and sends the temperature data to the video driver 111. The video driver 111 takes a video signal from outside, and sends a control signal and a video signal (DATA) to the display panel 100. The video driver 111 varies the operating frequency of the control signal sent to the display panel 100 in accordance with the temperature data obtained from the ADC 112. The video driver 111 also decimates or interpolates the video signal (DATA) in accordance with the operating frequency of the control signal.

The relationship between the temperature data and the operating frequency is determined by the relationship between the temperature of a semiconductor display device including a display panel and the maximum operating frequency. The operating frequency at a temperature may be selected so that efficient operation is achieved and better display quality is obtained.

For example, a frame frequency of 120 fps (frame per second) of a video signal at a room temperature and a high temperature allows image flicker to be less apparent, while a frame frequency of 60 fps at a low temperature ensures normal operation.

It is needless to say that the frame frequency is not limited to the aforementioned examples. In addition, the frame frequency may be set at three temperatures of a low temperature, a room temperature and a high temperature, or may be set at four or more temperatures.

According to such a configuration, better display quality at a room temperature and a high temperature and normal operation at a low temperature can both be achieved.

### EMBODIMENT MODE 2

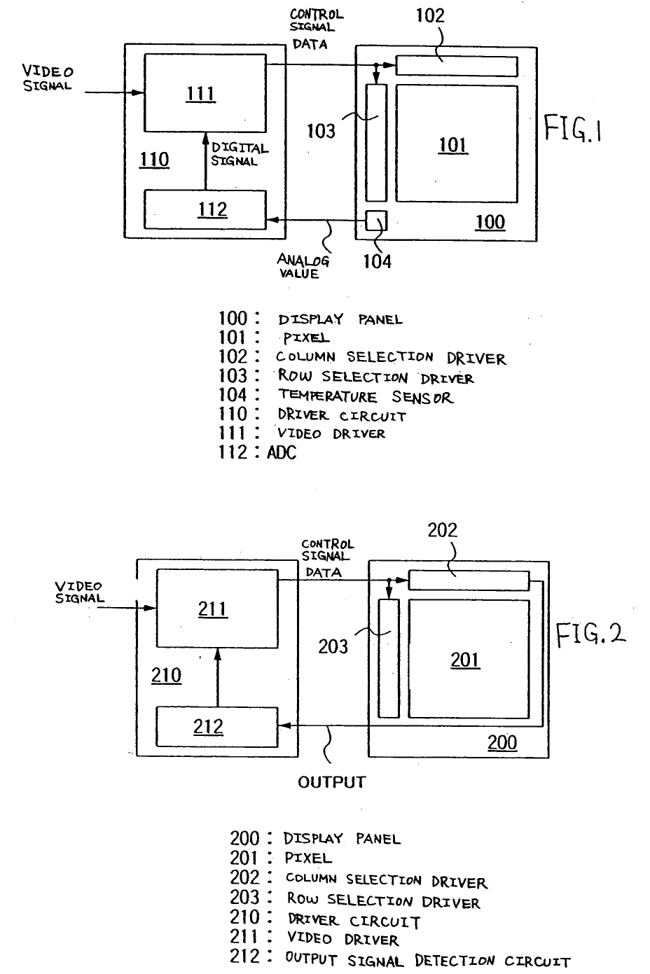

FIG. 2 shows an embodiment mode of the invention. According to this embodiment mode, the operating frequency is varied in accordance with an output signal of a semiconductor display device.

The invention comprises a display panel 200 and a driver circuit 210. The display panel 200 comprises a pixel 201, a column selection driver 202 and a row selection driver 203. The column selection driver 202 and the row selection driver 203 may be constituted by TFTs formed on the same insulator as the pixel 201, or may be attached onto an insulator by COG (Chip On Glass).

The driver circuit 210 comprises a video driver 211 and an output signal detection circuit 212. The column selection driver 202 receives a control signal and a video signal (DATA) from the video driver 211. The row selection driver 203 receives a control signal from the video driver 211. The row selection driver 203 scans the pixel 201 in accordance with the control signal whereas the column selection driver 202 writes the video signal (DATA) to the pixel 201 in accordance with the control signal. The written video signal (DATA) allows the pixel 201 to display a predetermined image.

The output signal detection circuit 212 monitors an output signal terminal (OUTPUT) of the column selection driver 202, and sends operating state data of the column selection driver 202 to the video driver 211. The video driver 211 takes a video signal from outside, and sends a control signal and a video signal (DATA) to the display panel 200. The video driver 211 varies the operating frequency of the control signal sent to the display panel 200 in accordance with the operating state data obtained from the output signal detection circuit 212. The video driver 211 also decimates or interpolates the video signal (DATA) in accordance with the operating frequency of the control signal.

For example, in the case of the last stage of a shift register of the column selection driver 202 being connected to the output signal terminal (OUTPUT), a pulse with a certain pulse width is outputted to the output signal terminal (OUTPUT) at a certain timing. When the timing and the pulse width of the pulse are predetermined ones, normal operation is obtained. Meanwhile, when the timing is shifted or the pulse width is increased or vanishes, normal operation is not obtained. When such a state in which normal operation is not obtained is detected, the video driver 211 decreases the operating frequency of the control signal.

The output signal terminal (OUTPUT) may be connected to the last stage of a shift register of the row selection driver 203. Alternatively, the output signal terminal (OUTPUT) may be connected to a terminal other than the shift register. For example, when the output signal terminal (OUTPUT) is connected to a wiring for supplying a video signal (DATA) to a pixel, it is possible to verify that a video signal (DATA) is supplied to the pixel. Instead, a plurality of output signal terminals (OUTPUTs) may be provided to monitor a plurality of drivers. In such a case, when normal operation is not obtained at one of the plurality of output signal terminals (OUTPUTs), the operating frequency is decreased.

As set forth above, when optimal operating frequency for the display panel 200 is automatically set, the best display quality can always be obtained while maintaining normal operation at a low temperature. Further, according to this embodiment mode, the operating frequency is determined by monitoring the operating state of the display panel 200, it is thus advantageous that the relationship between the temperature and the maximum operating frequency is not required to be checked in advance.

### EMBODIMENT MODE 3

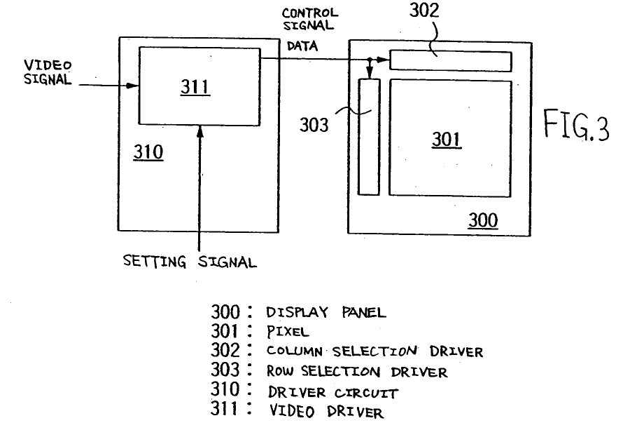

FIG. 3 shows an embodiment mode of the invention. According to this embodiment mode, the operating frequency is varied by an external setting signal.

The invention comprises a display panel 300 and a driver circuit 310. The display panel 300 comprises a pixel 301, a column selection driver 302 and a row selection driver 303. The column selection driver 302 and the row selection driver 303 may be constituted by TFTs formed on the same insulator as the pixel 301, or may be attached onto an insulator by COG (Chip On Glass).

The driver circuit 310 comprises a video driver 311. The column selection driver 302 receives a control signal and a video signal (DATA) from the video driver 311. The row selection driver 303 receives a control signal from the video driver 311. The row selection driver 303 scans the pixel 301 in accordance with the control signal, whereas the column selection driver 302 writes the video signal (DATA) to the pixel 301 in accordance with the control signal. The written video signal (DATA) allows the pixel 301 to display a predetermined image.

The video driver 311 takes a video signal from outside and sends a control signal and a video signal (DATA) to the display panel 300. At this time, the video driver 311 varies the operating frequency of the control signal sent to the display panel 300 in accordance with an external setting signal. The video driver 311 also decimates or interpolates the video signal (DATA) in accordance with the operating frequency of the control signal.

The setting signal is determined automatically or by switching. For example, the setting signal can be determined depending on the remaining amount of battery. According to this, when a small amount of battery remains, the operating frequency can be decreased to enter a power saving mode. Instead, for example a user can determine the operating frequency to set display quality and a range of operating temperature.

In this manner, the operating frequency of the display panel 300 can be set arbitrarily.

Note that a power source is connected to the semiconductor display device and the driver circuit that are shown in FIGS. 1 to 3, though it is omitted herein.

### EMBODIMENT 1

This embodiment shows an example of a temperature sensor that can be used in the invention.

The temperature sensor is classified into a number of types depending on the operating principle. For example, a temperature sensor using a thermistor operates by utilizing the resistance of the thermistor that is temperature dependent. In such a temperature sensor, the thermistor is connected in series to a resistor element that is temperature independent, and a voltage applied to the thermistor is measured by dividing the resistance of the power source voltage. Since the voltage is an analog value at this time, it is converted to a digital value by an ADC. An element in which a thermistor and an ADC are integrated into a single chip may also be used in the invention.

A temperature sensor using a thermocouple operates by utilizing thermoelectric power generated depending on the temperature of a junction of the thermocouple. Since the thermoelectric power is also an analog value at this time, it is converted to a digital value by an ADC.

Other temperature sensors such as a bimetallic temperature sensor and a mercury temperature sensor may also be employed in the invention.

### EMBODIMENT 2

Described in this embodiment is a semiconductor display device including pixels that are arranged in matrix of m rows and n columns.

FIG. 4 shows a line sequential writing driver that is an example of a column selection driver. A column selection driver 402 comprises a shift register 421, a first latch 422, a second latch 423, a level shifter 424, and an output buffer 425. Further, a start pulse SP, a clock pulse CK and a latch pulse LAT are inputted as control signals, and a video signal (DATA) is also inputted. A single DATA may be inputted or two or more of DATA may be inputted in parallel. When the number of DATA inputted in parallel is increased with the same frame frequency, the operating frequency can be decreased though more wirings are required.

The shift register 421 uses the start pulse SP and the clock pulse CK as timing signals to perform shift operation and sequentially selects S1 to Sn. The first latch 422 takes the DATA at the timing selected by the shift register 421 and outputs it to the second latch 423. The second latch 423 holds the output of the first latch 422 at the timing of the latch pulse LAT. A voltage of the output of the first latch 422 is amplified in the level shifter 424 while a current thereof is amplified in the output buffer 425. The output of the output buffer 425 is connected to a pixel, thus the DATA is supplied to pixels in a row selected by the row selection driver.

The DATA is sequentially taken for each of the columns S1 to Sn by the shift register 421, while it is simultaneously written to pixels in all the columns S1 to Sn. Accordingly, a writing period to the pixels can be prolonged.

The output of the shift register 421 in the column Sn is not connected to the shift register 421 in the subsequent column, but is outputted to the outside of the display panel as an output signal (OUTPUT). This output signal (OUTPUT) can be utilized for determining the operating frequency as the output signal (OUTPUT) shown in Embodiment Mode 2.

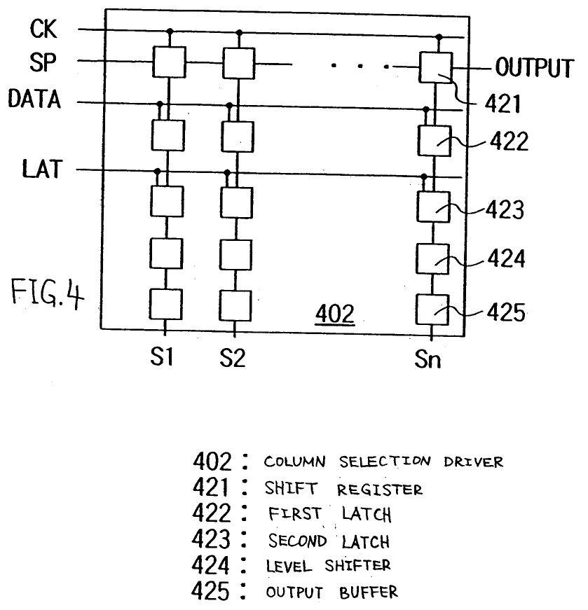

FIG. 5 shows an example of a row selection driver. A row selection driver 503 shown in FIG. 5 comprises a shift register 521, a level shifter 524 and an output buffer 525. Further, a start pulse SP and a clock pulse CK are inputted as control signals.

The shift register 521 uses the start pulse SP and the clock pulse CK as timing signals to perform shift operation and sequentially selects G1 to Gm. A voltage of the output of the shift register 521 is amplified in the level shifter 524 while a current thereof is amplified in the output buffer 525. The output of the output buffer 525 is connected to pixels, and sequentially scans pixels in a row G1 to Gm.

The output of the shift register 521 in the row Gm is not connected to the shift register 521 in the subsequent row, but is outputted to the outside of the display panel as an output signal (OUTPUT). This output signal (OUTPUT) can be utilized for determining the operating frequency as the output signal (OUTPUT) shown in Embodiment Mode 2.

Both or either of the output signals (OUTPUTs) of the column selection driver and the row selection driver may be utilized as the output signal (OUTPUT) shown in Embodiment Mode 2. In the case of utilizing either thereof, it is preferable to use the output signal (OUTPUT) of the column selection driver that requires higher operating frequency.

Although a line sequential writing method is described in this embodiment, a dot sequential writing method may also be adopted in which a video signal is written to each pixel. In that case, the shift register of the column selection driver sequentially selects an analog switch, and a video signal is inputted to the corresponding column by the analog switch.

### EMBODIMENT 3

Described in this embodiment is a video driver adopting a time gray scale method.

In the time gray scale method, a predetermined luminance is obtained by controlling a light emitting period. In the case of a video signal with n-bit gray scale levels, on the assumption that an n-bit video signal has a light emitting period of 2ⁿ⁻¹, a light emitting period is proportional to the number of bits of a video signal such that an (n−1)-bit video signal has a light emitting period of 2ⁿ⁻², and a 1-bit video signal has a light emitting period of 2⁰=1. At this time, a pixel is only switched between a light emitting state and a non-light emitting state. According to the time gray scale method, a video signal inputted as a digital signal can be transferred to a pixel without being converted to an analog signal, which results in a high quality image with high resistance to noise and improved reproducibility. Particularly in an organic EL element, gray scale display cannot be easily controlled with voltage because of a non-linear relationship between the voltage and the luminance. However, such a problem can be solved by adopting the time gray scale method in which gray scale display can be achieved while maintaining a driving voltage constant.

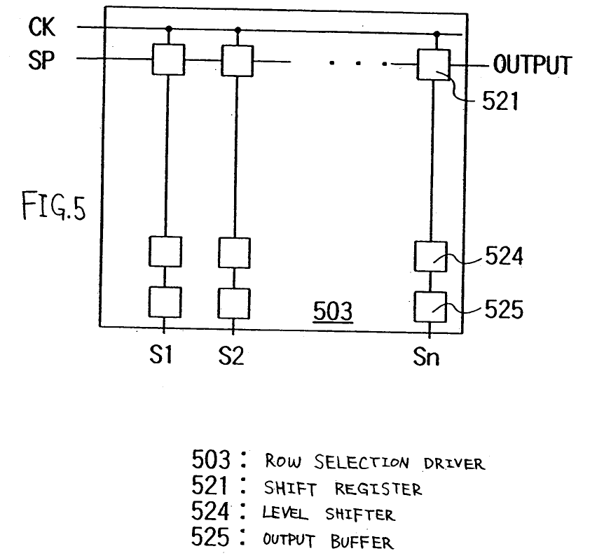

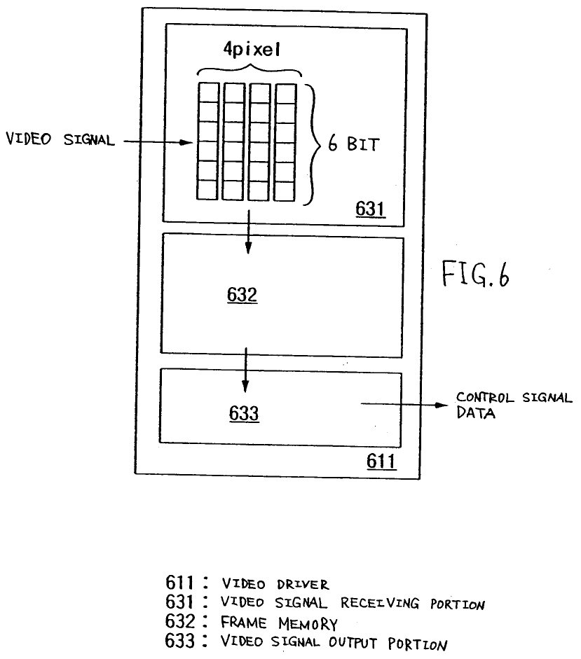

FIG. 6 shows an example of a video driver using the time gray scale method. A video driver 611 shown in FIG. 6 comprises a video signal receiving portion 631, a frame memory 632 and a video signal output portion 633. The video driver 611 shown here has four parallel outputs each having 6-bit gray scale levels. The four parallel outputs mean that the DATA is transferred in four parallels.

The video signal receiving portion 631 receives an external 6-bit video signal, and registers it in the frame memory 632 after the video signal being rearranged so as to be used in the time gray scale method. A video signal is sequentially inputted to each pixel in 6-bit parallels. The inputted video signals are temporarily held in a memory of 6×4, and then registered in the frame memory 632 from the first to the sixth bit in four pixel parallels. By this rearrangement, the gray scale levels are divided depending on respective light emitting periods to supply the DATA to a display panel.

The video signal output portion 633 outputs to the display panel the DATA registered in the frame memory 632 and a control signal for determining timing of taking the DATA. The DATA is sequentially outputted for each bit such that all the first bits are outputted for one frame and all the second bits are then outputted. Further in this embodiment, the DATA is outputted in 4-pixel parallels.

The frame frequency of a video signal inputted to the video driver 611 is not always equal to that of the DATA outputted to the display panel. For example, in the case where the video signal inputted to the video driver 611 has a frame frequency of 60 fps, and the DATA is outputted to the display panel with the same frame frequency, image flicker and pseudo contour may occur, leading to decreased display quality.

The time gray scale method is a method of displaying gray scale by averaging a light emitting state and non-light emitting state on the principle of persistence of vision. When the frame frequency is decreased, such persistence of vision does not work well, leading to image flicker.

In the time gray scale method, gray scale is displayed by providing different light emitting periods. For example, when a gray scale a=2ⁿ⁻¹ and a gray scale b=2ⁿ⁻¹ are displayed in adjacent pixels, the pixel of the gray scale a emits light in a display period of the n-th bit, whereas the pixel of the gray scale b emits light in a display period of the (n−1)-th bit. At this time, the gray scale varies continuously though the display period is reversed. Therefore, a noise-like line called pseudo contour may be apparent at the boundary between the pixel of the gray scale a and the pixel of the gray scale b.

Both of the image flicker and the pseudo contour are defects that decrease display quality, and thus are required to be suppressed as much as possible. It is effective to increase the frame frequency for the suppression method.

In particular, the pseudo contour is less apparent with a frame frequency of 100 fps or more. Since the pseudo contour occurs regardless of gray scale and luminance, the frame frequency is effectively increased in all gray scales.

As set forth above, the DATA is preferably outputted with a frame frequency of 100 fps or more.

However, the frequencies of the control signal and the DATA are increased in proportion to the frame frequency. For example, with a frame frequency of 120 fps, a display panel operates normally at a room temperature and a high temperature, though it does not operate normally at a low temperature. When normal operation is not obtained, images may be distorted or not be displayed at all.

Therefore, as described in the embodiment modes, the frame frequency outputted as DATA is varied by monitoring the temperature and the OUTPUT. As a result, better display quality with little image flicker and pseudo contour can be achieved at a room temperature and a high temperature, whereas normal operation without distorted images can be obtained at a low temperature.

### EMBODIMENT 4

Described in this embodiment is a method of varying the frame frequency.

In the case where a video signal inputted to a video driver has a constant frame frequency and the frame frequency of an outputted video signal (DATA) is varied, the frame is interpolated or decimated in accordance with changes in frame frequencies.

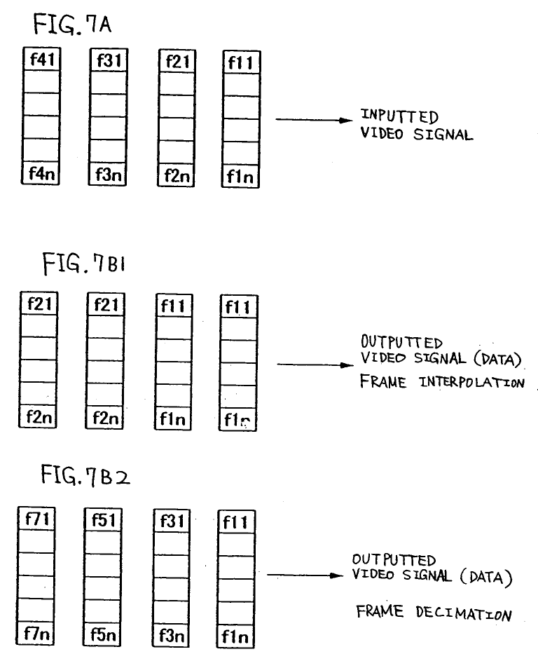

FIGS. 7A, 7B1 and 7B2 show a relationship between a video signal inputted to a video driver and an output DATA. FIG. 7A shows an inputted video signal in which one frame has n-bit gray scales. Reference numeral f11 denotes the first bit in the first frame, and f4n denotes the n-the bit in the fourth frame. An inputted video signal in FIG. 7A is sequentially inputted to the first frame, the second frame, . . . and the fourth frame.

FIG. 7B1 shows the case in which the frame frequency of an outputted video signal (DATA) is high. The outputted video signal (DATA) in FIG. 7B1 is outputted twice for each frame such that the first frame, the first frame, the second frame, the second frame. When the same video signal is continuously outputted to a plurality of frames, the frames are interpolated. By interpolating the frames, the DATA can be outputted with a higher frame frequency than that of a video signal inputted to the video driver. High frame frequency obtained in this manner allows high quality images to be displayed with little image flicker and pseudo contour.

FIG. 7B2 shows the case in which the frame frequency of an outputted video signal (DATA) is low. The outputted video signal (DATA) in FIG. 7B2 is outputted for every two frames such as the first frame, the third frame, the fifth frame, and the seventh frame. By decimating the frames in this manner, the frame frequency can be decreased. The decreased frame frequency allows to decrease the frequencies of the control signal and the DATA and to operate the display panel with accuracy.

Although the frame is interpolated by inputting the same DATA to the same frame twice, the invention is not limited to this. Any method can be applied to the invention such as a method of inputting the same DATA to the same frame three times and a method of inputting the same DATA twice to one of two frames.

Although the frame is decimated by outputting the same data for every two frames, the invention is not limited to this. Any method can be applied to the invention such as a method of outputting the same DATA for every three frames and a method of decimating one of three frames.

### EMBODIMENT 5

Described in this embodiment is a method of decreasing the frequencies of the control signal and the DATA by reducing gray scale levels.

When a video signal inputted to a video driver has a constant frame frequency and the frequencies of outputted control signal and DATA are required to be decreased, lower bits are reduced.

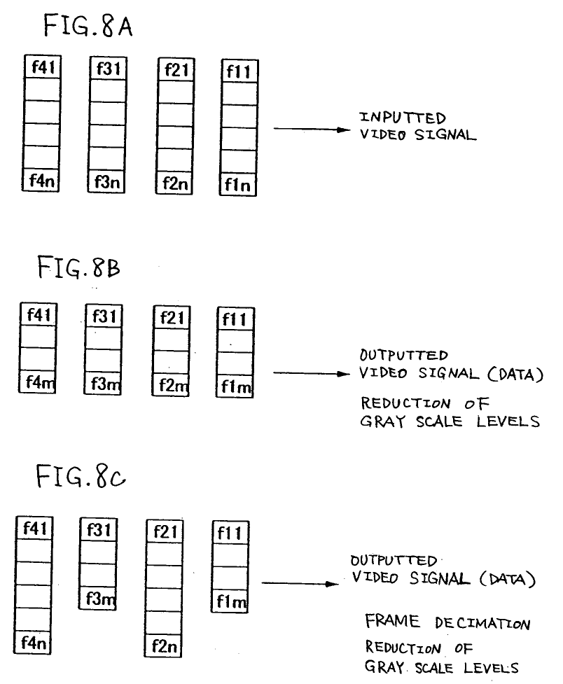

FIGS. 8A to 8C show the relationship between a video signal inputted to a video driver and an outputted DATA. FIG. 8A shows an inputted video signal in which one frame has n-bit gray scales. Reference numeral f11 denotes the first bit in the first frame, and f4n denotes the n-th bit in the fourth frame. An inputted video signal in FIG. 8A is sequentially inputted to the first frame, the second frame, . . . , and the fourth frame.

FIG. 8B shows an outputted video signal (DATA). In FIG. 8B, gray scale levels are reduced from n bits to m bits (n>m). When the gray scale levels are reduced, the amount of data supplied to a display panel is reduced with the same frame frequency, thus the frequencies of the control signal and the DATA can be decreased and the display panel can be operated with accuracy.

Alternatively, as shown in FIG. 8C, only lower bits can be reduced to decimate the frame.

### EMBODIMENT 6

The driving method of a semiconductor display device of the invention can be applied to various fields. Described in this embodiment are examples of electronic apparatuses to which the invention can be applied.

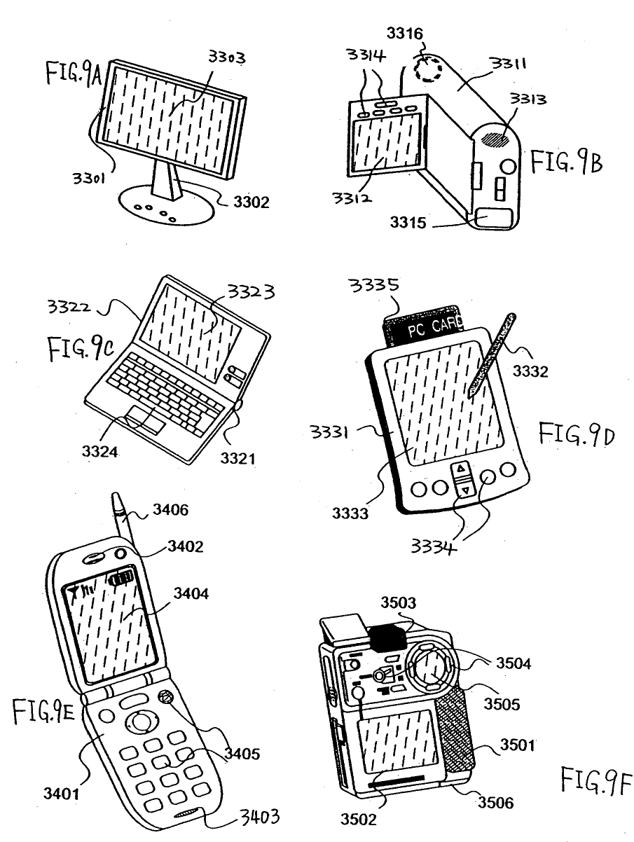

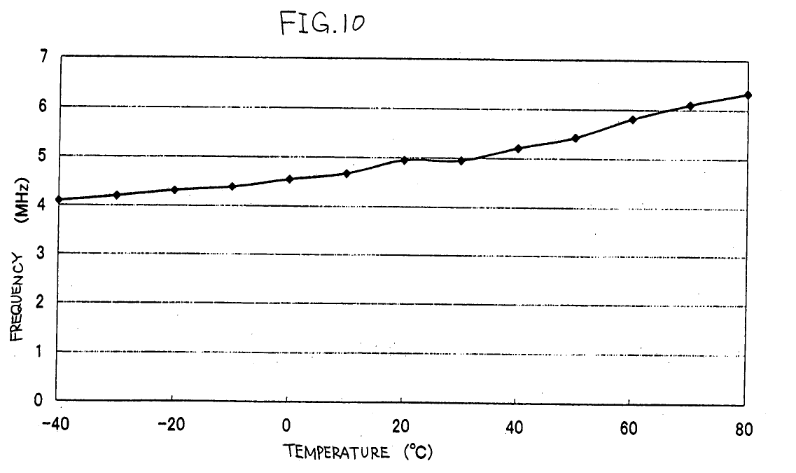

Such electronic apparatuses include a portable information terminal (electronic notebook, mobile computer, mobile phone and the like), a camera (a video camera and a digital camera), a personal computer, a television and the like. Specific examples of them are shown in FIGS. 9A to 9F.

FIG. 9A illustrates an EL display that includes a housing 3301, a support base 3302, a display portion 3303 and the like. According to the invention, an EL display incorporating the display portion 3303 can be completed.

FIG. 9B illustrates a video camera that includes a main body 3311, a display portion 3312, an audio input portion 3313, operating switches 3314, a battery 3315, an image receiving portion 3316 and the like. According to the invention, a video camera incorporating the display portion 3312 can be completed.

FIG. 9C illustrates a personal computer that includes a main body 3321, a housing 3322, a display portion 3323, a keyboard 3324 and the like. According to the invention, a personal computer incorporating the display portion 3323 can be completed.

FIG. 9D illustrates a portable information terminal that includes a main body 3331, a stylus 3332, a display portion 3333, operating buttons 3334, an external interface 3335 and the like. According to the invention, a portable information terminal incorporating the display portion 3333 can be completed.

FIG. 9E illustrates a mobile phone that includes a main body 3401, an audio output portion 3402, an audio input portion 3403, a display portion 3404, operating switches 3405, an antenna 3406 and the like. According to the invention, a mobile phone incorporating the display portion 3404 can be completed.

FIG. 9F illustrates a digital camera that includes a main body 3501, a display portion (A) 3502, an eye contact portion 3503, operating switches 3504, a display portion (B) 3505, a battery 3506 and the like. According to the invention, a digital camera incorporating the display portion (A) 3502 and the display portion (B) 3505 can be completed.

As set forth above, the application range of the invention is so wide that the invention can be applied to electronic apparatuses in all fields.

This application is based on Japanese Patent Application serial no. 2003426210 filed in Japan Patent Office on Dec. 24, 2003, the contents of which are hereby incorporated by reference.

1. A driver circuit of a semiconductor display device, comprising:
a temperature sensor for measuring a temperature of a display panel;
a video driver for supplying a control signal and a video signal;
an analog/digital converter for measuring an output value of the temperature sensor; and
a means for varying frequencies of the control signal and the video signal in accordance with a measurement result of the analog/digital converter.

2. A circuit according to claim 1,
wherein frequencies of the control signal and the video signal are varied by varying a frame frequency of the video signal.

3. A circuit according to claim 1,
wherein frequencies of the control signal and the video signal are varied by reducing the number of gray scale levels of the video signal.

4. An electronic apparatus using the driver circuit according to claim 1.

5. A driver circuit of a semiconductor display device, comprising:
an output signal detection circuit for monitoring an output signal terminal;
a video driver for supplying a control signal and a video signal; and
a means for varying frequencies of the control signal and the video signal in accordance with operating state data obtained from the output signal detection circuit.

6. A circuit according to claim 5,
wherein frequencies of the control signal and the video signal are varied by varying a frame frequency of the video signal.

7. A circuit according to claim 5,
wherein frequencies of the control signal and the video signal are varied by reducing the number of gray scale levels of the video signal.

8. An electronic apparatus using the driver circuit according to claim 5.

9. A driver circuit of a semiconductor display device, comprising:
a video driver for supplying a control signal and a video signal to a display panel; and
a means for varying frequencies of the control signal and the video signal in accordance with a setting signal inputted to the video driver.

10. A circuit according to claim 9,
wherein frequencies of the control signal and the video signal are varied by varying a frame frequency of the video signal.

11. A circuit according to claim 9,
wherein frequencies of the control signal and the video signal are varied by reducing the number of gray scale levels of the video signal.

12. An electronic apparatus using the driver circuit according to claim 9.

13. A driving method of a semiconductor display device comprising an analog/digital converter and a video driver, comprising:
measuring an output value of a temperature sensor by the analog/digital converter;
supplying a control signal and a video signal to a display panel by the video driver;
measuring a temperature of the display panel by the temperature sensor; and
varying frequencies of the control signal and the video signal in accordance with a measurement result of the analog/digital converter.

14. A method according to claim 13,
wherein frequencies of the control signal and the video signal are varied by varying a frame frequency of the video signal.

15. A method according to claim 13,
wherein frequencies of the control signal and the video signal are varied by reducing the number of gray scale levels of the video signal.

16. An electronic apparatus using the driving method according to claim 13.

17. A driving method of a semiconductor display device comprising an output signal detection circuit and a video driver, comprising:
monitoring an output signal terminal of a display panel by the output signal detection circuit;
supplying a control signal and a video signal to the display panel by the video driver; and
varying frequencies of the control signal and the video signal in accordance with operating state data obtained from the output signal detection circuit.

18. A method according to claim 17,
wherein frequencies of the control signal and the video signal are varied by varying a frame frequency of the video signal.

19. A method according to claim 17,
wherein frequencies of the control signal and the video signal are varied by reducing the number of gray scale levels of the video signal.

20. An electronic apparatus using the driving method according to claim 17.

21. A driving method of a semiconductor display device comprising a video driver, comprising:
supplying a control signal and a video signal to a display panel by the video driver; and
varying frequencies of the control signal and the video signal in accordance with a setting signal inputted to the video driver.

22. A method according to claim 21,
wherein frequencies of the control signal and the video signal are varied by varying a frame frequency of the video signal.

23. A method according to claim 21,
wherein frequencies of the control signal and the video signal are varied by reducing the number of gray scale levels of the video signal.

24. An electronic apparatus using the driving method according to claim 21.
